(19) United States
(12) Patent Application Publication
(10) Pub. No.: US 2025/0380309 A1
(43) Pub. Date: Dec. 11, 2025

(54) ALIGNMENT OF DUTY CYCLES OF AMBIENT IOT DEVICES ACCORDING TO THEIR DEVICE TYPE AND STORAGE SIZE

(71) Applicant: Lenovo (Singapore) Pte Limited, Singapore (SG)

(72) Inventors: Karthikeyan GANESAN, Nauheim (DE); Ali Ramadan Ali, Kraiburg am Inn (DE); Hyung-Nam Choi, Ottobrunn (DE); Ravi Kuchibhotla, Chicago, IL (US)

(21) Appl. No.: 18/737,733

(22) Filed: Jun. 7, 2024

(51) Int. Cl. H04W 74/0833; G16Y 10/75

(52) U.S. Cl. CPC H04W 74/0833; G16Y 10/75

(57) ABSTRACT

Various aspects of the present disclosure relate to an ambient Internet of things (AIoT) device reader with at least one memory and at least one processor coupled with the at least one memory and configured to cause the reader to transmit a configuration to at least one AIoT device, the configuration indicating a duty cycle associated with a at least one characteristic of the at least one AIoT device, and receive, within an inventory round, an inventory message from the at least one AIoT device having the at least one characteristic in a random access channel (RACH) occasion of the duty cycle.

### TECHNICAL FIELD

The present disclosure relates to wireless communications, and more specifically to configuring AIoT devices.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Ambient power-enabled devices, such as ambient power-enabled Internet of Things (IoT) devices, or AIoT devices, include battery-less devices that have limited energy storage capabilities (e.g., they store a limited amount of energy using capacitors) or other capability restrictions. These restricted devices may store energy by harvesting energy from the environment of the IoT device, such as via radio waves, light, heat, motion, and other energy/power sources available to the IoT device. Example AIoT devices and other restricted devices include location tags or stickers, such as tags attached to objects that enable a network server to track locations of the objects.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further include An ambient Internet of things (AIoT) device reader comprising at least one memory, and at least one processor coupled with the at least one memory and configured to cause the reader to transmit a configuration to at least one AIoT device, the configuration indicating a duty cycle associated with a at least one characteristic of the at least one AIoT device, and receive, within an inventory round, an inventory message from the at least one AIoT device having the at least one characteristic in a random access channel (RACH) occasion of the duty cycle.

In some implementations of the method and apparatuses described herein, the at least one characteristic comprises an energy storage size, a device type, or a combination thereof.

In some implementations of the method and apparatuses described herein, the configuration indicates one or more time multiplexed duty cycle within an inventory round, wherein 1) a first duty cycle having a first active time for AIoT devices having a first energy storage size, and 2) a second duty cycle having a second active time for AIoT devices having a second energy storage size, and wherein the first duty cycle and the second duty cycle are configured according to the respective energy storage sizes of each the associated AIoT devices.

In some implementations of the method and apparatuses described herein, the configuration indicates that the first active time period of the first duty cycle for AIoT devices having the first storage size is longer than the second active time period of the second duty cycle for AIoT devices having the second storage size, and the first storage size is greater than the second storage size.

In some implementations of the method and apparatuses described herein, the at least one characteristic comprises a device type selected from the group consisting of a Device 1, a Device 2a, and a Device 2b.

In some implementations of the method and apparatuses described herein, the duty cycle is selected from a first duty cycle associated with Device 1, a second duty cycle associated with Device 2a, and a third duty cycle associated with Device 2b.

In some implementations of the method and apparatuses described herein, the configuration indicates a second duty cycle associated with at least one second characteristic, and the at least one processor is further configured to cause the reader to receive a second inventory message from an AIoT device having the at least one second characteristic in a RACH occasion of the second duty cycle.

In some implementations of the method and apparatuses described herein, the configuration further indicates at least one of a cyclic shift, a preamble, and a base sequence to be used by AIoT devices having the at least one characteristic.

In some implementations of the method and apparatuses described herein, the configuration further indicates a condition for skipping at least one resource occasion during an active duration of the duty cycle.

In some implementations of the method and apparatuses described herein, the configuration indicates a second duty cycle comprising active and inactive durations that are different from active and inactive durations of the duty cycle, a resource occasion of an active duration of the first duty cycle is aligned with a resource occasion of an active duration of the second duty cycle, and the at least one processor is further configured to cause the reader to transmit a second configuration to the plurality of AIoT devices during the aligned resource occasion.

In some implementations of the method and apparatuses described herein, the at least one processor is further configured to cause the reader to receive an electronic product code (EPC) from an AIoT and select the at least one characteristic based on an association with the EPC.

Some implementations of the method and apparatuses described herein may further include an AIoT device comprising at least one memory and at least one processor coupled with the at least one memory and configured to cause the AIoT device to receive a configuration, the configuration indicating a duty cycle associated with at least one device characteristic, compare the at least one device characteristic to a characteristic of the AIoT device, and when the AIoT device has the at least one device characteristic, transmit an inventory message in a random access channel (RACH) occasion of the duty cycle within an inventory round.

### BRIEF DESCRIPTION OF THE DRAWINGS

FIG. 1 illustrates an example of a wireless communications system in accordance with aspects of the present disclosure.

FIG. 2 illustrates an example of messaging between an AIoT reader and an ambient-powered IoT device in accordance with aspects of the present disclosure.

FIG. 3 illustrates an example of communication between a reader and a device during an inventory round in accordance with aspects of the present disclosure.

FIG. 4 illustrates an example of duty cycles for device groups in an inventory round in accordance with aspects of the present disclosure.

FIG. 5 illustrates an example of communications between AIoT devices and a reader 220 the same duty cycles in accordance with aspects of the present disclosure.

FIG. 6 illustrates an example of a user equipment (UE) 600 in accordance with aspects of the present disclosure.

FIG. 7 illustrates an example of a processor 700 in accordance with aspects of the present disclosure.

FIG. 8 illustrates an example of a network equipment (NE) 800 in accordance with aspects of the present disclosure.

FIG. 9 illustrates a flowchart of method performed by a UE or NE in accordance with aspects of the present disclosure.

FIG. 10 illustrates a flowchart of method performed by an AIoT device in accordance with aspects of the present disclosure.

### DETAILED DESCRIPTION

For billions of IoT devices are expected to be deployed in future communication systems. However, the costs and logistics associated with providing batteries for so many devices present major hurdles to adoption. Accordingly, recent efforts have focused on devices that consume very low power and harvest energy which may be stored in capacitors. These efforts have identified three different types of AIoT devices:

Device A: No energy storage, no independent signal generation (backscattering transmission).

Device B: Has energy storage, no independent signal generation (backscattering transmission). The use of stored energy can include amplification of reflected signals.

Device C: Has energy storage, has independent signal generation (active RF components for generating and transmitting signals).

In addition, the Third Generation Partnership Project (3GPP) has classified AIoT devices into the following three categories according to capabilities of the devices:

Device 1: ˜1 μW peak power consumption, has energy storage, initial sampling frequency offset (SFO) up to 10^{X} ppm, neither DL nor UL amplification in the device. The device's UL transmission is backscattered on a carrier wave provided externally.

Device 2a: ≤a few hundred μW peak power consumption, has energy storage, initial SFO up to 10^{X} ppm, one or both of DL and UL amplification in the device. The device's UL transmission is backscattered on a carrier wave provided externally.

Device 2b: ≤a few hundred μW peak power consumption, has energy storage, initial SFO up to 10^{X} ppm, one or both of DL and UL amplification in the device. The device's UL transmission is generated internally by the device.

There are different topologies and deployment scenarios possible for AIoT. Some of these topologies include a topology 1a where a base station acts as reader and as source of carrier wave, topology 1b where a base station acts as a reader but another device is used as a source of the carrier wave, and a topology 2 where a base station acts as a controller and another intermediate node used as a reader and as a source of carrier wave.

There can be as many as 150 devices per 100 square meters in an indoor factory area, for example, and AIoT devices in such a limited area perform random access and data transmissions to provide electronic product code (EPC) IDs to a network. Conventional RFID devices use protocols such as aloha protocol, tree protocol, Q protocol etc., to access a channel, resolve collisions and transmit data. The energy of such devices is typically limited by their storage capacitor size, and the charging time depends on their energy harvesting circuitry, e.g. the resistance and capacitance of the circuitry.

Different devices have different circuitry, and many different devices with different energy storage and charging characteristics can be present within a limited area. Some devices are only capable of short duty cycles due to limited energy storage, and different devices may be preconfigured with different duty cycles. These different capabilities present challenges when using a single reader to read multiple types of devices.

In AIoT devices, the charging time due to energy harvesting can be assumed up to several tens of seconds. The lack of enough energy in a capacitor to sustainably operate an AIot device within an inventory round may lead to device outage. The following Table 1 illustrates how long it can take in msec to charge AIoT devices with different capacitance based on resistance of the devices:

TABLE 1

| R | | | | | | | | | | |
|---|---|---|---|---|---|---|---|---|---|---|
| (kΩ) | 1 μF | 2 μF | 3 μF | 4 μF | 5 μF | 6 μF | 7 μF | 8 μF | 9 μF | 10 μF |
| 1 | 5 | 10 | 15 | 20 | 25 | 30 | 35 | 40 | 45 | 50 |
| 20 | 100 | 200 | 300 | 400 | 500 | 600 | 700 | 800 | 900 | 1000 |
| 100 | 500 | 1000 | 1500 | 2000 | 2500 | 3000 | 3500 | 4000 | 4500 | 5000 |
| 1000 | 5000 | 10000 | 15000 | 20000 | 25000 | 30000 | 35000 | 40000 | 45000 | 50000 |

The present disclosure can increase device energy and signaling efficiency by sending a configuration message from a reader to the devices. The configuration message may indicate different duty cycles for groups of devices with different characteristics, which can optimize device performance and efficiency. The configuration message may also indicate at least one trigger condition. The trigger condition may relate to device capabilities, e.g. capacitor sizes, to provide more efficient communications. Device efficiency can be improved by managing uplink UL transmissions to increase energy harvesting times during an inventory round and reducing potential signal collision.

Aspects of the present disclosure are described in the context of a wireless communications system.

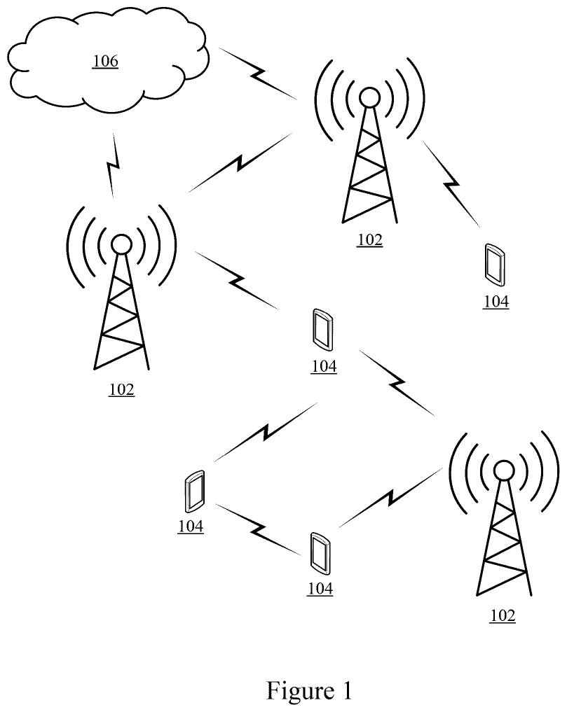

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a

communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the technology can utilize a configuration from an ambient Internet of things (AIoT) device reader, to provide efficient operation and messaging AIoT devices and the reader. The reader and devices are generally operated and controlled by users, and therefore may be referred to as UEs, e.g. UEs 104. In some embodiments, the reader may be a base station, or NE 102.

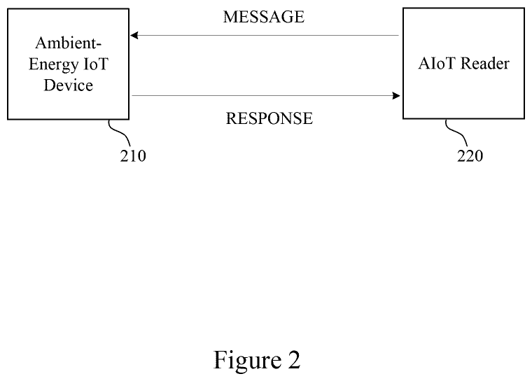

FIG. 2 illustrates an example of messaging between a reader device 220 configured to communicate with AIoT devices and an AIoT device 210 in accordance with aspects of the present disclosure. In FIG. 2, the AIoT reader 220 sends a message to the AIoT device 210. The message may be referred to as a reader-to-device or R2D signal. The message may comprise, for example, a configuration, a command, a trigger condition, associated command parameters, a nonce, a query, a signature, etc. The message may cause the IoT device 210 to perform an action or operation.

In some cases, the message may be associated with an inventory request, such as when the IoT device 210 is a tag on an object (e.g., a television). A command request message may request information about the associated object, such as an electronic product code (EPC) for the object. In response to the inventory request, the device 210 may transmit a signal comprising an EPC. This signal may be referred to as a device-to-reader or D2R signal. The EPC may be an identifier, or ID, which identifies an object associated with the device 220. In addition, the EPC may be used to identify one or more characteristic of the device 220.

In some cases, the message may include a request to the device 220 to perform a read operation, a write operation, a control operation, an enable operation, and/or a disable operation. For example, the command may include command parameters that instruct the AIoT device 210 to stop transmitting RF signals for a certain time period.

In other cases, the message may be an application specific command and/or device specific command, such as a command that instructs the device 210 to perform a specific function or action. For example, the message may include command parameters that cause the device 210 to perform a simple measurement or data capture (e.g., measure a surrounding temperature), and transmit the data back to the AIoT reader 220.

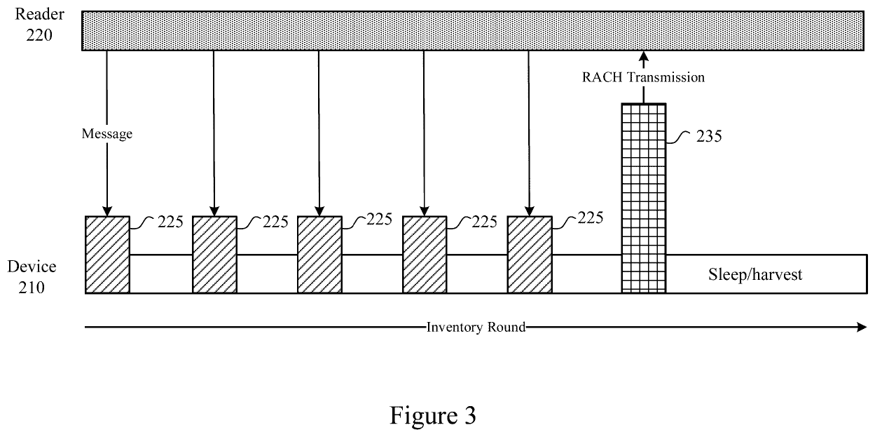

FIG. 3 illustrates an example of communication between a reader 220 and a device 210 during an inventory round in accordance with aspects of the present disclosure. At the start of an inventory round, the reader 220 transmits a downlink signal 225 to the device 210. The downlink signal 225 may be broadcast to a plurality of devices 210 within an area such as a warehouse or a factory. An inventory round may have a predetermined time duration such as 1 second or 10 seconds with a predetermined number of resource occasions. Each resource occasion may comprise at least one uplink slot and at least one downlink slot.

The reader 220 sends a series of downlink signals 225 to the device 210 at different times within the inventory round. The downlink signal 225 may comprise one or more of the signals described above with respect to FIG. 2. At least one downlink signal 225 is received by the device 210 as well as other devices in the area, and in response, the device 210 transmits an uplink signal 235 to the reader 220 over a random access channel (RACH). In the context of inventory management, the uplink signal 235 may comprise at least an EPC of the device 210.

The device 210 can periodically wake up to monitor for the downlink signals 225 within the inventory round. Once the inventory of the device 210 is finished, the device may sleep until the end of the inventory round and harvest energy while sleeping. In addition, the device may sleep in between, or during, downlink signal 225 instances and harvest energy during those times.

The device 210 consumes power to receive and transmit signals, and can recover power when not receiving or transmitting. Accordingly, the number and duration of Rx and Tx intervals are important to managing energy of the device 210. In some embodiments, a device 210 may benefit from minimizing power consumption within the inventory round to maintain RAM (volatile) memory.

For example, a device with 2 μF capacitance as energy storage may have an available energy of 1 μJ. For reception, periodic synchronization may be about 55 μW, and sleep state power consumption to maintain RAM memory may be 0.5 μW per query round, where each query round may be 10 ms. The Tx power consumption may be around 500 μW which includes the 2 transmission opportunities for random access and EPC ID transmission and 2 reception opportunities to receive a configuration. Meanwhile, the harvesting time with 20 kOhm resistance may be around 200 msec to attain a full charge of 1 μJ.

The total number occasions that the AIoT device 210 may sustainably operate for receiving only is 1 μJ/0.055 μJ, which is around 18 query rounds. Considering the transmission of the device 210, then the available energy for transmission should be 1 μJ/0.055 μJ>500 μW, which could be within the 12th query round. Of course, this is only an example to demonstrate the significance of managing reception, transmission and harvesting times for a device 210 to operate sustainably through inventory rounds.

In some embodiments, the reader 220 is aware of characteristics of a set of devices 210 with which the reader 220 is communicating. The reader may be aware of characteristics of the devices 210 by being preconfigured with parameters for the devices, by using EPC data from the devices, e.g. by comparing EPC data to a table with device information, by receiving indications from the devices indicating their characteristics, etc. The characteristics may include a device type, e.g. whether the device is a Device 1, Device 2a, or Device 2b as explained above. Other examples of device characteristics of a device 210 include energy storage size (capacity), available energy, energy harvesting capabilities, resistance, memory, transmission power consumption, reception power consumption, etc.

The reader 220 can use the characteristics of devices 210 to configure different duty cycles including the number and durations of active (e.g. ON or awake) and inactive (e.g. OFF or sleep) durations in an inventory round. A longer sleep time may be used to harvest sufficient energy for a larger energy storage size, and a device 210 with a larger storage size can stay awake for a longer time duration to transmit an uplink signal (e.g. RACH transmission) 235. A device 210 with a smaller storage size may sufficiently harvest energy, e.g. fill its capacitor, in less time than a device 210 with larger storage size.

In an embodiment, the reader 220 transmits a configuration to the device 210 in at least one downlink signal 225. The configuration may be a configuration for the device 210, e.g. a message that comprises information which, when processed by the device 210, configures one or more parameter of the device 210. The parameter may be a transmission or reception parameter, e.g. parameters for a duty cycle. one or more condition-based trigger, etc.

In an embodiment, the reader 220 transmits a configuration comprising an indication for a set of duty cycles associated with a respective set of device characteristics. The reader 220 may transmit a group configuration comprising a grouping or set of device types and/or storage sizes which may have different duty cycle-based operations. The duty cycles may be time multiplexed within an inventory round, and each group or set of devices 210 may be assigned one duty cycle-based wake-up operation according to the device type and/or storage size.

The device characteristics may be device characteristics as described above, e.g. storage size, device type, resistance, power consumption, etc. Each set of duty cycles may be associated with one or more of device characteristics. In an example, when the characteristic is a device type, a duty cycle for an inventory period may be associated with each device type.

The configuration message transmitted by the reader 220 may comprise, or indicate, a condition-based trigger. The slot offset of different reception cycles (e.g. resource occasions) may be aligned so that R2D messages can be received by all device types. However, a periodic messag may be skipped by some device type/storage sizes if the message isn't transmitted within its on-duration time. Accordingly, some messages such as configuration messages may be transmitted by the reader 220 when the reception times of the devices 210 are all aligned.

Embodiments of the present disclosure relate to time multiplexed duty cycle-based operation considering that the device wakes up to receive periodic message within an inventory round. In such an embodiment, the reader 220 may create time multiplexed different duty cycles comprising active and inactive durations for devices 210 within an inventory round according to one or more device characteristic. In a configured duty cycle, a device 210 may periodically wake-up to receive messages from the reader 220 such as synchronization signals and command messages during active times, and the inactive or sleep times can be used to harvest energy to store in the capacitor of the device 210.

A longer inactive time can be utilized to harvest sufficient energy for larger energy storage sizes. However, devices 210 with larger storage size with sufficient available energy can operate for a longer time compared to devices 210 with smaller storage sizes. A device 210 with smaller storage size may need less time to harvest sufficient energy and may also operate for a shorter duration. Hence there is a trade-off between the sustainable operation of devices 210 according to their storage size, power consumption to operate each device type etc.

The reader 220 may have awareness of characteristics of the devices 210 with which the reader is communicating based on the EPC IDs of the devices. The reader 220 may know the characteristics of a population of devices 210 entering an inventory round and can configure appropriate time multiplexed duty cycles accordingly.

A device 210 may transmit one or more of its characteristics to the reader 220, e.g. at the RACH transmission occasion 235. In an example, the device 210 transmits a device type identifier associated with the device to the reader 220, as an example device 1—passive (˜1 μw), device 2a—passive (˜100 μw), device 2b—active (˜100 μw) etc. In another example, the device 210 transmits an indication associated with its storage size. Numerous other examples are possible.

The reader 220 may group devices 210 according to device characteristics and determine a set of duty cycles associated with a respective set of device characteristics. For example, the reader 220 may group a set of devices 210 and determine a set of duty cycles for a set of devices based on whether the devices are capable of backscattering transmissions or active transmissions.

The reader 220 may use specific communication parameters based on shared characteristics of a set of devices 210. The reader may communicate the communication parameters in a downlink signal 225, e.g. a configuration message, and use those parameters for a specific set of devices. Examples of the communication parameters include a cyclic shift, a preamble, and a base sequence for a set of devices 210. In an embodiment, the reader 220 transmits the communication parameters (e.g. cyclic shift, preamble, base sequence, etc.) associated with one or more device characteristic to devices 210 in a configuration message, and devices that share the one or more device characteristic use the communication parameters to communicate with the reader 210 for at least one inventory round.

In an embodiment, the reader 220 indicates one or more RACH occasion within an inventory round to be used by a set of devices 210 in a configuration message. Accordingly, each device 210 of a set of devices sharing one or more characteristic may transmit uplink signals 235 at the same RACH occasion(s) in an inventory round.

The reader 220 may provide instructions for RACH communications for a set of devices 210 sharing a characteristic in a configuration message. For example, the configuration message may indicate a RACH type, e.g. a two-step RACH or a 4-step RACH, to be used by a set of devices. In addition or as an alternative, the configuration message may indicate a stage in a RACH procedure in which a set of devices 210 transmit an EPC. In one example, the configuration message instructs a set of devices 210 to transmit an EPC to the reader 220 in the MsgA phase or step 1 of a 2-step RACH procedure. In another example, the configuration message instructs a set of devices 210 to transmit an EPC to the reader 220 in the third stage, or the Msg3 stage, of a 4-step RACH procedure.

In some embodiments, devices 210 may be categorized and grouped according to specific ranges of energy storage size. The storage size categorizations may be preconfigured at the reader 220 or determined by the reader 220 based, for example, on the storage sizes of devices 210 with which the reader 220 is communicating. An example of categories or groupings of devices by capacitor storage is a first group comprising devices 210 with capacitor storge of 0.5 to 1 μF, a second group comprising devices 210 with storage of 1.5 to 2 μF, etc. In some embodiments, a device 210 may transmit a storage size category associated with the device to the reader 220.

The reader 220 may configure one or more duty cycle for each device group. In particular, the reader 220 may configure active and inactive times within an inventory round for a group of devices 210 sharing at least one characteristic in consideration of that characteristic. The reader 220 may configure the devices by transmitting a configuration message at or towards the beginning of an inventory round. In an example, the reader 220 transmits a configuration message as the first data transmission in an inventory round.

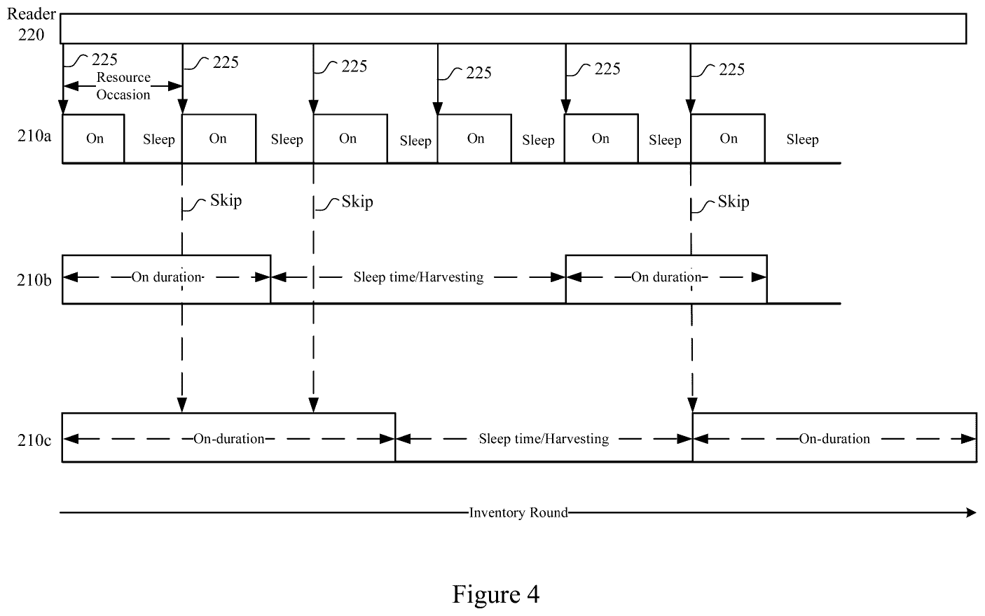

FIG. 4 illustrates an example of duty cycles for device groups in an inventory round in accordance with aspects of the present disclosure. Three different groups or sets of devices are shown in FIG. 4: a first set 210a, a second set 210b, and a third set 210c.

The first set of devices 210a may be grouped according to one or more shared characteristic such as a device type, e.g. Device 1, an energy storage size, e.g. up to 1 μF, etc. Similarly, the second set of devices 210b may be grouped according to one or more shared characteristic such as Device type 2a, a storage size from 3 to 4 μF, etc., and the third set of devices 210c may be grouped according to one or more characteristic such as Device type 2b and a storage size from 5 to 6 μF.

In the embodiment of FIG. 4, the third set of devices 210c has a higher energy storage size than the second set of devices 210b, which in turn have higher energy storage size than the first set of devices 210a. Accordingly, the third set of devices 210c have a longer on-duration than the second set of devices 210b, which have longer on-durations than the first set of devices 210a. Therefore, the duty cycles for the three sets of devices 210, which comprise alternating active (ON) and inactive (OFF, sleep, etc.) times, are different from one another. Durations of the respective duty cycles may be preconfigured at the devices 210 or adopted by the devices 210 based on a configuration message received from a reader 220.

In the embodiment of FIG. 4, a single duty cycle of the first set of devices 210a corresponds to a single resource occasion. The resource occasion may comprise at least one uplink slot for uplink transmissions to the reader 220, and at least one downlink slot in which the device 210 can receive downlink transmissions, e.g. synchronization signals, command signals and configuration messages, from the reader 220.

A starting slot offset for a discontinuous reception (DRX) interval, e.g. an inventory round, may be aligned for a plurality of devices 210 so that synchronization signals and R2D messages from the reader 220 may be received by all devices in sets 210a, 210b and 210c. The reader 220 may establish the alignment by information in an R2D message, e.g. a configuration message.

To ensure that the devices 210 successfully receive and transmit data as intended in an inventory round, the devices may be configured by the reader 220 to provide time multiplexed operations. Some devices 210 may be capable of always ON operations and may be configured differently than devices 210 without such capabilities. Devices 210 may be configured with duty cycles having active and inactive intervals appropriate for the device type and configured to provide sufficient power harvesting opportunities to transmit and receive data in synchronization with other device types within an inventory round. Some sets of devices 210 may be configured to skip resource occasions during active intervals when certain trigger conditions are met, as will be explained in more detail below.

In some embodiments, devices 210 may be configured with various operations related to active and inactive states of the duty cycles. Four options of the operations configured at a device 210 are as follows.

Option 1: For a device 210 not configured with duty cycle-based operation and hence determined as always ON, 1) for a device 210 with sufficient energy to activate its processing module, the device wakes up only when the received RF power exceeds the threshold. 2) Once the device 210 wakes up, it monitors for R2D transmissions continuously until the remaining energy in the storage is insufficient to activate its processing module (e.g., fully discharged) or the received RF power falls below the activation threshold. 3) Once the device 210 is fully discharged, it goes to sleep and harvests energy. 4) The device 210 does not retain memory, and does not run a clock during sleep.

Option 2: For a device 210 configured with duty cycle-based operations, 1) when the device 210 is fully charged or charged to a threshold level, e.g. X % of the total energy capacity, the device wakes up when the received RF power exceeds an activation threshold. 2) When the device 210 wakes up, it monitors for downlink transmissions from a reader 220 for a set time duration, e.g. an on duration, to avoid full energy discharge. 3) If the device 210 does not receive any downlink transmissions from the reader 220 within the set time duration, the device enters the inactive/sleep/OFF mode and harvests energy until fully charged, or charged to the X % threshold of the total energy capacity. In this option, the device 210 does not retain memory or run a clock during the inactive periods.

Option 3: For a device 210 configured with duty cycle-based operations, the device 210 may operate in the same way as points 1), 2) and 3) of option 2, except the device 210 retains a memory and runs a clock during inactive times.

Option 4: For a device 210 configured with duty cycle-based operations, 1) a reader 220 transmits R2D signals or physical reader to device channel (PRDCH) indicating active/awake/ON and inactive/sleep/OFF occasions or durations to extend device 210 availability. 2) The device 210 wakes up according to the active/awake/ON occasion and monitors for R2D transmissions for the active time duration. If the device 210 does not receive a R2D transmission during the active time duration, the device goes to sleep and harvests energy until the next active occasion. 4) The device 210 retains memory and runs the clock during inactive periods.

The reader 220 may transmit a trigger to a device 210. The trigger may be a conditional trigger which indicates to the device to perform an operation when the condition is met. The conditional trigger may be periodically transmitted in configuration messages from the reader 220. In the embodiment of FIG. 4, any of the downlink transmissions 225 may comprise a conditional trigger.

In some embodiments, when a device 210 satisfies the condition of the trigger, then the device may transmit (and receive transmissions) within a specified time window, e.g. a time window specified by the configuration message. The resource occasions or time slots in which the device 210 transmits within the specified time window may be randomized.

In an embodiment, a device 210 may randomly select a resource occasion in which to transmit from a set of resource occasions within a time window. A device 210 may initiate the time window in the slot in which the trigger condition is received. Accordingly, a reader 220 may specify a duration of a time window associated with a trigger condition, and the device 210 may automatically initiate the time window at the trigger condition reception slot.

A condition-based trigger may contain one or more of the following conditions to select devices 210 for transmission within the time window:
1) Available energy at the capacitor. For example, devices 210 having less available energy may be configured transmit at the earliest opportunity. A device 210 may compare its available energy with a threshold value provided in the trigger condition to determine whether it is selected for transmission within the time window.
2) Incident received power level, pathloss or distance. For example, devices 210 having less received power or located farther away from a reader 220 may be selected for transmission at the earliest opportunity. A device 210 may compare a metric for received power, pathloss or distance to a threshold value provided in the trigger condition to determine whether it is selected for transmission within the time window.
3) Device type. For example, devices 210 of, e.g., device type 1 can selected by the trigger condition for transmission within the time window.
4) Device storage size. For example, devices 210 having storage size that satisfies a trigger condition may be selected for transmission within the time window. A device 210 may compare its storage size (energy storage capacity, capacitor size, etc.) to a value or range, and when the storage size meets the value or is within the range, the device transmits within the time window.

A device 210 may be configured to skip an instance of receiving messages from a reader 220 and one or more resource occasion, e.g. to forego receiving downlink transmissions 225 and/or associated uplink transmissions 235, within an active time of the device 210. In an embodiment, the device 210 is configured to skip receiving a trigger message from the reader 220 that triggers communications during resource occasions of a duty cycle based on a trigger condition. Such skipping may be facilitated by devices with the ability to count slots in an inactive or sleep state, or by running a separate clock. Benefits of skipping include reduced collisions, simplify processing for the reader 220, and saving power at the devices 210.

A skipping configuration for devices may be based on one or more of the following conditions: 1) A device type, 2) energy storage size, 3) whether the device is configured for always ON operation, 4) the ability of the device to count slots while in an inactive or sleep mode, 5) the amount of energy available in the energy storage, and 6) the incident received power level, pathloss or distance from the reader 220. When a reader 220 configures the devices for skipping with a configuration message, the reader may take any of the above conditions into consideration, e.g. by transmitting a trigger condition for skipping one or more resource occasion when one or more of the conditions above are satisfied. In addition or as an alternative, a device 210 may be preconfigured to skip resource occasions based one or more condition.

FIG. 4 shows several skipping instances. In FIG. 4, skipping instances are indicated by the dashed vertical lines. In the example of FIG. 4, devices 210a may be low power Device 1 type devices without memory, and receive all downlink transmissions 225. Devices 210b, which may be Device 2a type devices, are configured to receive downlink transmissions 225 (and transmit uplink transmissions) at the first resource occasion in each active period or On duration, and skip remaining downlink transmissions 225 within the active periods. The devices 210c, which may be Device 2b device types, are capable of retaining memory during inactive or sleep cycles, only receive and transmit signals during the first resource occasion in the inventory round and skip all subsequent resource occasions.

A configuration message may provide information about skipping periodic R2D messages within the on durations of sets of devices 210 such that devices with certain characteristics, e.g. the devices 210c, only receive downlink signals 225 and participate in resource occasions at the beginning of the first on-duration in an inventory period, which are aligned and used by all sets of devices 210. Important system information messages, e.g. system reconfiguration messages or messages indicating dynamic adjustment of parameters such as window duration of the aloha protocol, etc., may be transmitted only at times for which ON-durations of all sets of devices are aligned.

Accordingly, a skipping configuration message may provide information about skipping periodic R2D trigger messages 225 within the on-duration and only monitoring R2D messages received at the beginning of the on-duration that are aligned and read by multiple time multiplexed duty cycles, and skipping other instances R2D messages which occur during active periods or On durations of duty cycles.

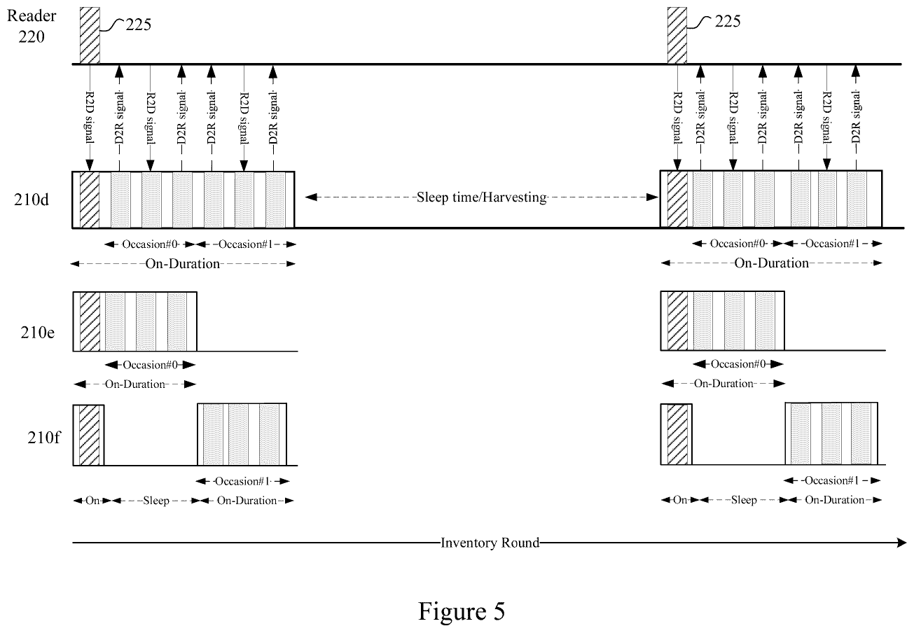

FIG. 5 illustrates an example of communications between AIoT devices 210 and a reader 220 within the same duty cycles in accordance with aspects of the present disclosure. A reader 220 transmits a downlink signal 225 which is received by all devices 210 at the start of the inventory round. The signal 225 may be a configuration message, and may include a trigger condition as described above. In addition, the signal 225 may be considered as a trigger that triggers participation in one or more associated resource occasion.

The devices 210 in FIG. 5 may have the same characteristics and be capable of operating within the same active period or On duration comprising two resource occasions, occasion #0 and occasion #1, and to be inactive or sleep for the same duration between sets of two active resource occasions. In the example of FIG. 5, each resource occasion comprises two D2R signals and one R2D signal.

As seen in FIG. 5, different devices may enter an inactive or sleep state at different times. The device 210d is active for both resource occasions, occasion #0 and occasion #1. Device 210e receives a message 225 at the start of the active duty cycles, participates in occasion #0, and enters a sleep state for occasion #1. Device 210f also receives message 225 at the start of the active duty cycles, but device 210f sleeps during occasion #0 and participates in occasion #1.

Devices 210e and 210f may select the on-durations for specific resource occasions randomly based on a configuration from the reader 225. For example, the message 225 may configure devices with the characteristics of device 210e and 210f to select a random resource occasion in an active part of the duty cycle in which to participate. In other embodiments, the devices may skip certain resource occasions, e.g. occasion #0 or #1, based on whether a trigger condition is satisfied. For example, if the amount of energy stored in device 210f is below a threshold, the device 210f may skip the first resource occasion and participate in the second resource occasion. Thus, there are several possible conditions for which devices may adopt the different configurations shown in FIG. 5.

The present disclosure describes novel aspects of a reader 220 and a device 210. In one aspect, time multiplexed duty cycle-based operations are described considering that the device 210 wakes up to receive periodic messages within an inventory round.

In another aspect, the reader 220 may create different time multiplexed duty cycles (cycles of active/ON periods and, inactive OFF/sleep/harvesting periods) within an inventory round according to a device type and/or storage size, wherein the device 210 may periodically wake-up to receive the synchronization signals, R2D messages etc. from the reader 220, and the sleep times can be utilized to harvest energy to store in the device's capacitor.

In another aspect, the reader 220 may have device type awareness and/or storage size awareness of each Ambient IoT device 210 tagged according to their EPC ID.

In another aspect, the reader 220 may configure one or more duty cycle for each device type/storage size, thereby grouping device types and/or storage sizes to a duty cycle as part of the initial inventory round.

In another aspect, the slot offset of one or more duty cycles can be aligned so that the synchronization signals, R2D messages etc. can be received by devices 210 of all device types and storage sizes.

In another aspect, an R2D transmission may contain a condition-based trigger which can be periodically transmitted.

In another aspect, R2D periodic trigger messages can be configured to be skipped at the device side.

In another aspect, a device 210 may enter a sleep state earlier within its on-duration.

In another aspect, a device 210 may first select an On duration at the beginning for its transmission, and secondly a resource occasion within each on-duration may be randomly chosen.

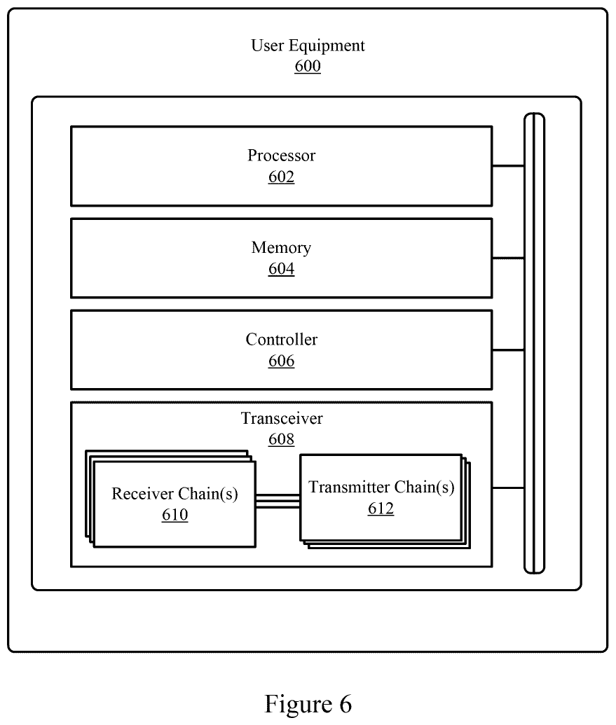

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for transmitting a configuration to at least one AIoT device.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

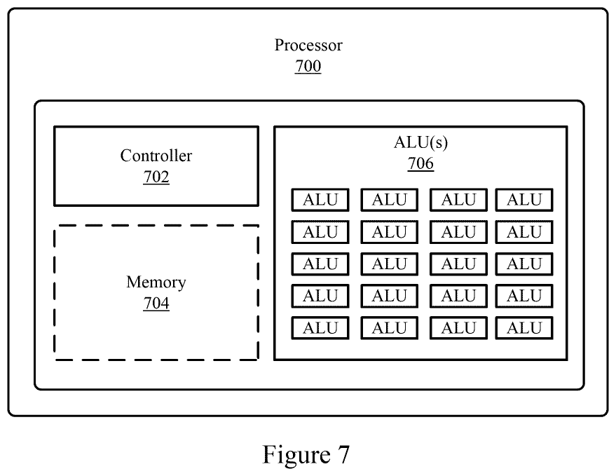

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for transmitting a configuration to at least one AIoT device.

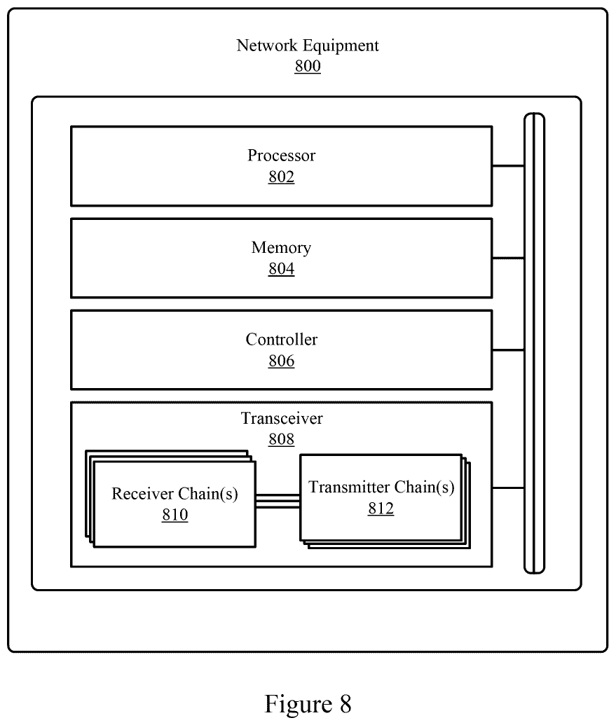

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for transmitting a configuration to at least one AIoT device.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or a wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

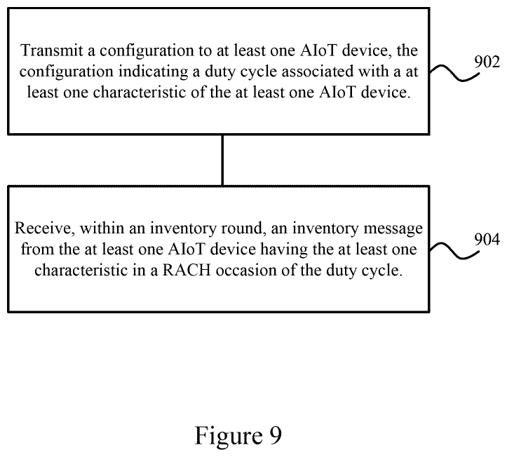

FIG. 9 illustrates a flowchart of a method in accordance with aspects of the present disclosure. The operations of the method may be implemented by a UE or NE as described herein. In some implementations, the UE or NE may execute a set of instructions to control the function elements of the UE or NE to perform the described functions.

At 902, the method may include transmitting a configuration to at least one AIoT device, the configuration indicating a duty cycle associated with a at least one characteristic of the at least one AIoT device. The operations of 902 may be performed in accordance with examples as described herein. In some implementations, aspects of the operations of 902 may be performed by a UE as described with reference to FIG. 6 or a NE as described with reference to FIG. 7.

At 904, the method may include receiving, within an inventory round, an inventory message from the at least one AIoT device having the at least one characteristic in a RACH occasion of the duty cycle. The operations of 904 may be performed in accordance with examples as described herein. In some implementations, aspects of the operations of 904 may be performed by a UE as described with reference to FIG. 6 or a NE as described with reference to FIG. 7.

It should be noted that the method described herein describes a possible implementation, and that the operations and the steps may be rearranged or otherwise modified and that other implementations are possible.

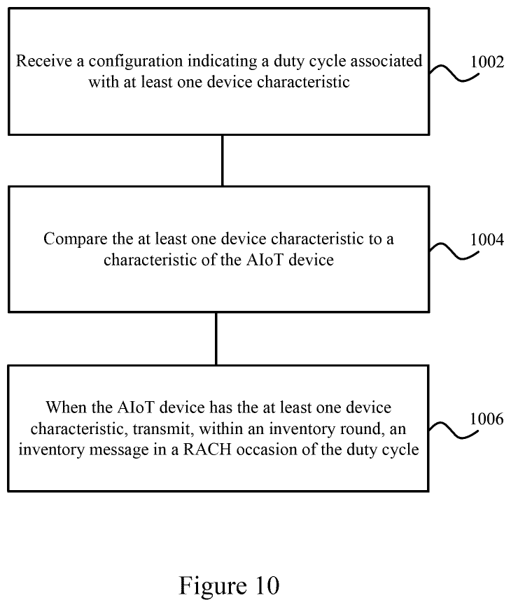

FIG. 10 illustrates a flowchart of a method in accordance with aspects of the present disclosure. The operations of the method may be implemented by an AIoT device as described herein. In some implementations, the AIoT device may execute a set of instructions to control the function elements of the AIoT device to perform the described functions.

At 1002, the method may include receiving a configuration, the configuration indicating a duty cycle associated with and at least one device characteristic. The operations of 1002 may be performed in accordance with examples as described herein.

At 1004, the method may include compare the at least one device characteristic to a characteristic of the AIoT device. The operations of 1004 may be performed in accordance with examples as described herein.

At 1006, the method may include transmitting an inventory message in a RACH occasion of the duty cycle within an inventory round when the AIoT device has the at least one device characteristic. The operations of 1006 may be performed in accordance with examples as described herein.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An ambient Internet of things (AIoT) device reader comprising:
at least one memory; and
at least one processor coupled with the at least one memory and configured to cause the reader to:
transmit a configuration to at least one AIoT device, the configuration indicating a duty cycle associated with a at least one characteristic of the at least one AIoT device; and
receive, within an inventory round, an inventory message from the at least one AIoT device having the at least one characteristic in a random access channel (RACH) occasion of the duty cycle.

2. The reader of claim 1, wherein the at least one characteristic comprises an energy storage size, a device type, or a combination thereof.

3. The reader of claim 2, wherein the configuration indicates one or more time multiplexed duty cycle within an inventory round,
wherein 1) a first duty cycle having a first active time for AIoT devices having a first energy storage size, and 2) a second duty cycle having a second active time for AIoT devices having a second energy storage size, and
wherein the first duty cycle and the second duty cycle are configured according to the respective energy storage sizes of the associated AIoT devices.

4. A reader of claim 3, wherein the configuration indicates that the first active time period of the first duty cycle for AIoT devices having the first storage size is longer than the second active time period of the second duty cycle for AIoT devices having the second storage size, and the first storage size is greater than the second storage size.

5. The reader of claim 1, wherein the at least one characteristic comprises a device type selected from the group consisting of a Device 1, a Device 2a, and a Device 2b.

6. The reader of claim 5, wherein the duty cycle is selected from a first duty cycle associated with Device 1, a second duty cycle associated with Device 2a, and a third duty cycle associated with Device 2b.

7. The reader of claim 1, wherein the configuration indicates a second duty cycle associated with at least one second characteristic, and
wherein the at least one processor is further configured to cause the reader to:
receive a second inventory message from an AIoT device having the at least one second characteristic in a RACH occasion of the second duty cycle.

8. The reader of claim 1, wherein the configuration further indicates at least one of a cyclic shift, a preamble, and a base sequence to be used by AIoT devices having the at least one characteristic.

9. The reader of claim 1, wherein the configuration further indicates a condition for skipping at least one resource occasion during an active duration of the duty cycle.

10. The reader of claim 1, wherein the configuration indicates a second duty cycle comprising active and inactive durations that are different from active and inactive durations of the duty cycle,
wherein a resource occasion of an active duration of the first duty cycle is aligned with a resource occasion of an active duration of the second duty cycle, and
wherein the at least one processor is further configured to cause the reader to:
transmit a second configuration to the plurality of AIoT devices during the aligned resource occasion.

11. The reader of claim 1, wherein the at least one processor is further configured to cause the reader to:
receive an electronic product code (EPC) from an AIoT; and
select the at least one characteristic based on an association with the EPC.

12. A processor for wireless communication, comprising:
at least one controller coupled with at least one memory and configured to cause the processor to:
transmit a configuration to at least one ambient Internet of things (AIoT) device, the configuration indicating a duty cycle associated with a at least one characteristic of the at least one AIoT device; and
receive, within an inventory round, an inventory message from the at least one AIoT device having the at least one characteristic in a random access channel (RACH) occasion of the duty cycle.

13. The processor of claim 12, wherein the at least one characteristic comprises an energy storage capacity.

14. The processor of claim 12, wherein the configuration indicates one or more time multiplexed duty cycle within an inventory round,
wherein 1) a first duty cycle having a first active time for AIoT devices having a first energy storage size, and 2) a second duty cycle having a second active time for AIoT devices having a second energy storage size, and
wherein the first duty cycle and the second duty cycle are configured according to the respective energy storage sizes of the associated AIoT devices.

15. The processor of claim 11, wherein the at least one characteristic comprises a device type selected from the group consisting of a Device 1, a Device 2a, and a Device 2b.

16. The processor of claim 14, wherein the duty cycle is selected from a first duty cycle associated with Device 1, a second duty cycle associated with Device 2a, and a third duty cycle associated with Device 2b.

17. The processor of claim 12, wherein the configuration indicates a second duty cycle associated with at least one second characteristic, and
wherein the controller is further configured to cause the processor to:
receive a second inventory message from an AIoT device having the at least one second characteristic in a RACH occasion of the second duty cycle.

18. The processor of claim 12, wherein the configuration further indicates at least one of a cyclic shift, a preamble, and a base sequence to be used by AIoT devices having the at least one characteristic.

19. The processor of claim 12, wherein the configuration further indicates a condition for skipping at least one resource occasion during an active duration of the duty cycle.

20. An ambient Internet of things (AIoT) device, comprising:
at least one memory; and
at least one processor coupled with the at least one memory and configured to cause the AIoT device to:
receive a configuration, the configuration indicating a duty cycle associated with at least one device characteristic;
compare the at least one device characteristic to a characteristic of the AIoT device; and
when the AIoT device has the at least one device characteristic, transmit an inventory message in a random access channel (RACH) occasion of the duty cycle within an inventory round.
